(19) United States
(12) Patent Application Publication
(10) Pub. No.: US 2009/0036199 A1
(43) Pub. Date: Feb. 5, 2009

(54) GAME OF SKILL AND METHOD OF OPERATING

(75) Inventors: David A. Myus, Green Bay, WI (US); John J. Kotlarik, Green Bay, WI (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: BAY TEK GAMES, INC., Pulaski, WI (US)

(21) Appl. No.: 11/830,073

(22) Filed: Jul. 30, 2007

(51) Int. Cl. A63F 13/06

(52) U.S. Cl. 463/23

(57) ABSTRACT

A system and method for operating a game of skill to provide awards or prizes to players of the game when the player has been successful in completing the game task. The game of skill is operated at a current skill level and the game monitors a rule parameter, such as a winning percentage or payout percentage, as the game is played. If the rule parameter exceeds a maximum limit, the difficulty level of the game is adjusted. Likewise, if the rule parameter is below a minimum limit, the difficulty level of the game is decreased. At each and every difficulty level, the player is able to succeed in winning the game of skill.

### FIELD OF THE INVENTION

The present invention generally relates to arcade-type games that return prizes or tickets based upon the skill level of a player during the game play. More specifically, the present invention relates to a method of operating an arcade game that automatically modifies the difficulty level of the game based upon the success level of past players.

### BACKGROUND OF THE INVENTION

A common type of arcade game found in family amusement centers and retail establishments is a redemption arcade game. A redemption game is one in which a player is awarded with tickets, tokens or other items redeemable for prizes from a prize counter that services many games and is typically located at a central location. One problem associated with redemption games that award tickets, tokens or other items that require separate redemption is the lack of excitement when the tickets or tokens are awarded to the player. Another problem with games that do not directly award prizes is that one or more workers must be present at the prize redemption counter for a player to redeem tickets/tokens for receiving a prize.

In an attempt to overcome the problems of redemption games, prize games have been introduced that dispense prizes directly from the game machine itself. Many of these game machines are centered around a game of skill where the player controls some aspect of the game, such as a moving circle of light bulbs, a rotating wheel or the movement of a coin through an apparatus. During game play, the player activates a switch, button or lever to stop the movement of the game at a desired prize location. The player wins a prize if the final location of the moving game field is aligned with a prize area. In many of these games, a first level prize is awarded for a player completing a first level of the game. If the player wishes to proceed, the player can elect not to receive the first level prize and can instead move to the next level of the game. This process continues until the player reaches the highest level of the game, at which time successful completion of the game will result in the awarding of a large prize. Since the cost of each individual game play is only a fraction of the large prize value, owners of these types of games of skill have an incentive to control the number of large prizes awarded based upon the number of game plays or the overall payout of the machine.

One known method of controlling the number of prizes awarded to players is to control the difficulty level of the game. The difficulty level is typically invisible to the player before he or she begins to play and remains invisible to the player even during and after play. For example, in some known games involving moving lights in the pattern of light bulbs, the light always moves at substantially the same speed. As the light moves in front of prize areas, the player attempts to stop the light and win the prize. Because the light moves at substantially the same speed at all times, the light is in front of the prize area for a fixed amount of time; for example 100 milliseconds. However, it is known to adjust the difficulty level of the game by providing a time less than the time the light is in front of the prize in which the player must select the light. For example, if the light is in front of the prize for 100 milliseconds, the game machine may be set to allow the light to continue past the prize unless the player stops the light in 70 milliseconds, or 50 milliseconds, or another time period less than 100 milliseconds. Although the player always has the ability to win the game at every difficulty level, increasing the difficulty level ensures that a fewer number of prizes will be awarded during game play.

In other types of redemption games, a player must stop the movement of a rotating wheel such that prize markings on the wheel align with fixed markings. Although the rotation of the wheel may be constant for various different difficulty levels, the number of degrees of rotation of the wheel after the player operates a control switch may vary. As an example, the longer the lead time between the operation of the switch and the stopping of the wheel, the more difficult it is for the player to judge where the wheel will stop after the switch has been depressed. As an example, a low difficulty level may allow the wheel to rotate only 2° after the switch has been depressed. A more difficult level will allow the wheel to rotate 5° after the switch has been depressed, while the most difficult level may allow the wheel to rotate 10° after the switch has been depressed.

In prior systems, the owner/operator of the arcade-type redemption game or merchandise game can manually adjust the difficulty level of the game based upon the operator's observation of the game payout over a period of time. Although the operator is able to adjust the difficulty level of the game to award fewer prizes, prior art systems require the operator to remember to adjust the difficulty level of the game at set periods. Oftentimes, operators would forget to adjust the game, resulting in an undesirable payout over a number of games. Likewise, if the difficulty level of the game is set too high for an extended period of time, players will become discouraged and no longer play the game, which also causes the revenue generated by the game to substantially decrease.

Therefore, a need exists for an arcade game that automatically adjusts the difficulty level of the game machine based upon a rule parameter, such as payout percentage or winning percentage for players over a number of game plays. Further, a need exists for a game machine that automatically adjusts the operation of the game and provides a report to an owner/operator detailing how the game has been operated over a period of time.

### SUMMARY OF THE INVENTION

The present invention generally relates to a method of operating a game of skill, such as an arcade game, that returns prizes, tickets or tokens to a player based upon the player's ability to complete a game task. More specifically, the present invention relates to a method and game of skill that adjusts the difficulty level of the game based upon the success rate of players over a selected number of game plays. The automatic adjustment of the difficulty level of the game of skill allows the game of skill to return a desired percentage range of prizes based upon the number of games played.

The game of skill generally includes a game cabinet and game field that is controlled by a control system within the arcade game. The arcade game may include a plurality of prizes, tickets or tokens that are awarded to the current player upon successful completion of the game. In one embodiment, the plurality of prizes are assigned to one of multiple levels where one of the prize levels includes large prizes that are awarded to the player upon completion of multiple levels of the game play.

The control system of the game of skill operates the game of skill to initially determine whether payment for the game has been received from a current player. If the required payment has been received from the current player, the control system operates the game at a current difficulty level. The current difficulty level may be the difficulty level initially entered into the game by the owner/operator during the game setup or may be adjusted from the original difficulty level by the operation of the control system.

As the game is operated at the current difficulty level, the control system determines whether the current player has been successful at completing the game. Based upon whether the current player is successful at completing the game, the control system updates a rule parameter, such as the winning percentage of the game or the payout percentage based upon the results from the current player. The updated rule parameter may be based upon the number of game plays since the game of skill was initially activated or may be based upon the number of game plays since the last update to the difficulty level.

After the game of skill has been played more than a user selected number of times, the control system compares the updated rule parameter for the game to both a maximum limit and a minimum limit. Specifically, the control system compares the rule parameter to a maximum limit and, if the rule parameter exceeds the maximum limit, the control system increases the difficulty level of the game. If the control system determines that the rule parameter is below a minimum limit, the difficulty level of the game is decreased to make the game easier to play for future players.

Once the difficulty level of the game has been adjusted based upon the updated rule parameter, the control system can operate the game at the now current, adjusted difficulty level for the next player. Alternatively, the control system can delay the implementation of the updated difficulty level for either a period of time or number of game plays after the adjustment to the difficulty level. The delay in implementation of the adjusted difficulty level ensures that a player who begins playing the game will not see a change to the difficulty level as long as the player continues to play. The delay in the implementation of the adjusted difficulty level may also require the game to be turned off before the difficulty level is adjusted.

During operation of the game of skill, the control system updates the rule parameter for the game continuously and increases or decreases the difficulty level after the game has been played more than an update threshold number of times. After the game has been played more than the update threshold number of game plays, the control system compares the rule parameter to both the maximum and minimum limits and adjusts the difficulty level accordingly. In this manner, the control system of the game of skill modifies the game play to maintain the rule parameter of the game within a desired range.

### BRIEF DESCRIPTION OF THE DRAWINGS

The drawings illustrate the best mode presently contemplated of carrying out the invention. In the drawings:

FIG. 1 is a perspective view of an arcade game having a game field and multiple prize levels;

FIG. 2 is a magnified view of the game field;

FIG. 3 is a flowchart illustrating the operation of the control system to adjust the difficulty level of the game based upon the success of past players;

FIG. 4 is a flowchart illustrating additional operating steps for use when prize levels are awarded at more than one level; and

FIG. 5 is a pair of screen shots showing the various difficulty levels for each round of the game play.

### DETAILED DESCRIPTION OF THE INVENTION

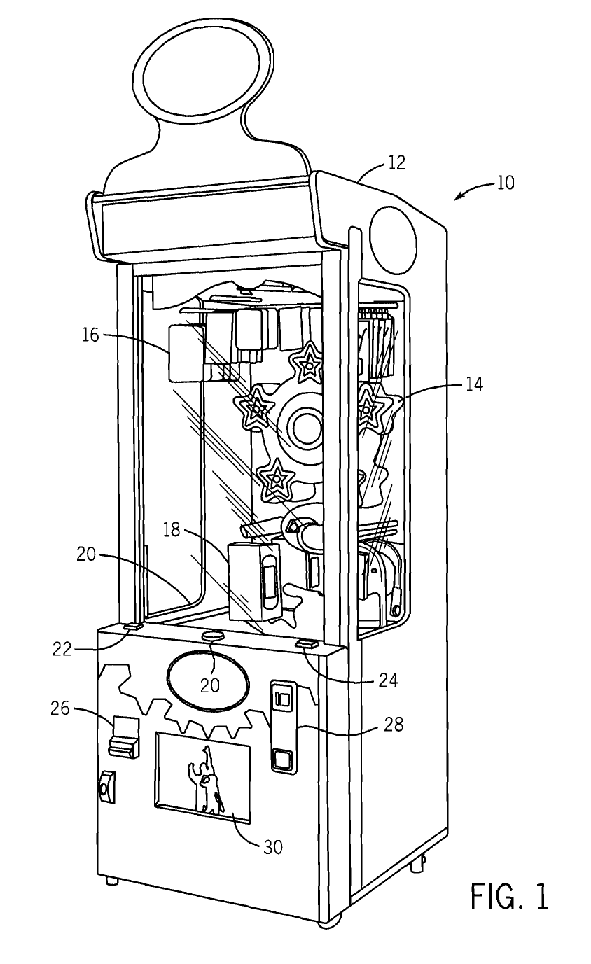

FIG. 1 illustrates an arcade game 10 that operates in accordance with the method of the present disclosure. The arcade game 10 generally includes an outer cabinet 12 that encloses the game field 14 and a series of individual prizes to be dispensed upon successful completion of the game play. In the embodiment shown in FIG. 1, the arcade game 10 includes a first level of prizes 16 and a second level of prizes 18, although it is contemplated that different numbers of prize levels could be utilized while operating within the scope of the present disclosure.

Although the arcade game 10 shown in FIG. 1 is a merchandising game that returns prizes to the player, it is contemplated that the arcade game 10 could also be a redemption-type arcade game that returns tickets or tokens to a player upon successful completion of the game play. Throughout the disclosure, it should be understood that the arcade game could be either a redemption game or a merchandising game while operating within the scope of the present disclosure.

The arcade game 10 comprises a game of skill and includes an activation switch 20 that can be used by a player to control the operation of the game field 14. The cabinet 12 includes a pair of selection buttons 22, 24 that allow the player to interact with the game. As is conventional, the cabinet 12 includes a bill validator and a coin slot 28 that allow the player to enter the required payment for the playing of the game. A prize door 30 allows the player to access any prizes won during the playing of the game.

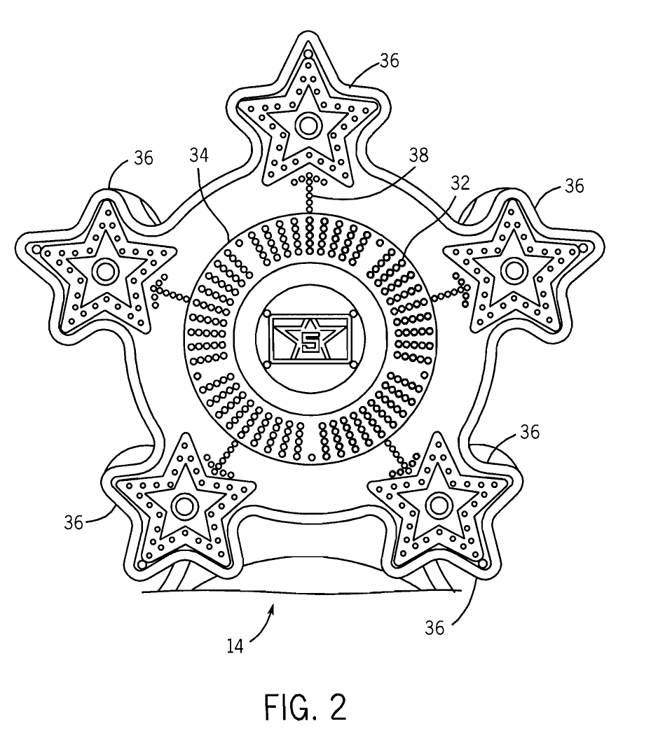

FIG. 2 illustrates the game field 14 of the arcade game shown in FIG. 1. Although a specific game field 14 is shown as a preferred embodiment, it should be understood that various different game fields 14 can be utilized while operating within the scope of the present invention.

In the game field 14 shown in FIG. 2, the game field 14 has a series of LED rows 32 that are sequentially lit to create a moving light element that travels in either a clockwise or counter-clockwise direction around the circular game path 34. As the LED rows 32 are lit to move the light element around the game path 34, the user must depress the activation switch 20 (FIG. 1) to stop the lit LED row in alignment with one of the targets 36. Each of the targets 36 includes an indicator 38 that identifies the active target 36. To succeed, the player must stop the moving row of LEDs at the indicator 38 to successfully hit the target 36. In the first level of game play, the player must successfully stop the moving LEDs in alignment with each of the five targets 36 shown in FIG. 2.

If the player is successful in activating each of the five targets 36, the player can select to receive a prize from the first level of prizes 16 shown in FIG. 1. However, if the user elects to proceed to the next level of game play, the user depresses the selection button 24 and the game play resumes. As the game play resumes, the player must again stop the moving LEDs 32 in alignment with the indicators 38 for each of the five targets 36. During the second level of play, the difficulty level is increased by both increasing the speed of the moving LEDs and decreasing the width of the moving LEDs around the game path 34.

If the user is successful at activating each of the targets 36 during the second level of play, the user is awarded a large prize from the second level of prizes 18, as shown in FIG. 1.

In a typical setup of the arcade game 10 shown in FIG. 1, each play of the game will require the user to insert between 25 cents and two dollars for each play. Typically, the first level of prizes 16 have a value of $0.10-$1.50 while the second level of prizes 18 will have a value that may range from as little as $5.00 to as much as $250.00. Thus, it is important to set up the arcade game 10 such that the second level of prizes 18 are awarded infrequently enough such that the arcade game 10 remains profitable for the owner/operator.

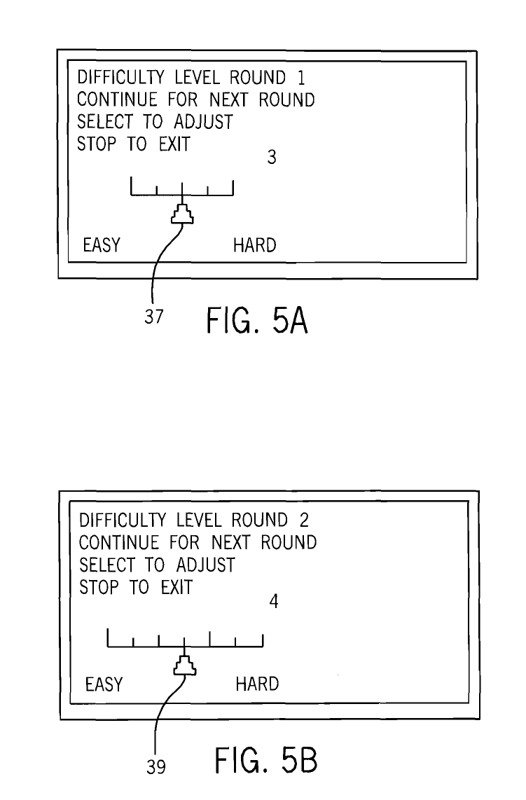

In the specific game shown in FIGS. 1 and 2, the difficulty level for both the first and second levels is shown by the screen shots of FIG. 5. As shown in FIG. 5, the difficulty level 37 for round 1 can be adjusted to five different settings ranging from easy to hard. The difficulty level 39 for round 2 can be adjusted to seven different settings. Although the game shown in FIGS. 1 and 2 includes different difficulty settings for each level of game play, it is contemplated that only a single difficulty level could be utilized or that different levels of difficulty could be utilized for each game level while operating within the scope of the present invention.

As described previously, the difficulty levels for each of the first and second game levels control the speed at which the LEDs move around the game path and also control the lag time between operation of the activation switch 20 and when the moving LEDs stop. As previously described, the faster the lights move and the greater the lag time between the depression of the activation switch 20 and termination of movement of the LEDs increases the difficulty level of game play. However, it should be understood that even at the most difficult settings available for the arcade game 10, it is still possible for the most skilled player to be successful in achieving a winning play on the arcade game 10.

During the initial setup of the arcade game 10, the operator utilizes the setup screens of FIG. 5 to choose the initial difficulty settings. These initial setup values may be based upon the value of prizes at the first prize level 16 and the second prize level 18, as well as the cost of each game play. Listed below is a sample of the difficulty settings based upon a fifty cent per play and various cost levels for each of the prizes. It should be understood that these difficulty settings can be modified by the owner/operator of the arcade game.

| | .50 Per Play | | .50 Per Play | | .50 Per Play | |
|---|---|---|---|---|---|---|
| | Option 1 | | Option 2 | | Option 3 | |
| | | Difficulty | | Difficulty | | Difficulty |
| | Cost | Setting | Cost | Setting | Cost | Setting |
| Small | $.50 | Round | $.75 | Round | $.50 | Round One |
| Prize | | One (3) | | One (3) | | (3) |
| Super | $50 | Round | $75 | Round | $125 | Round |
| Prize | | Two (4) | | Two (6) | | Two (6) |

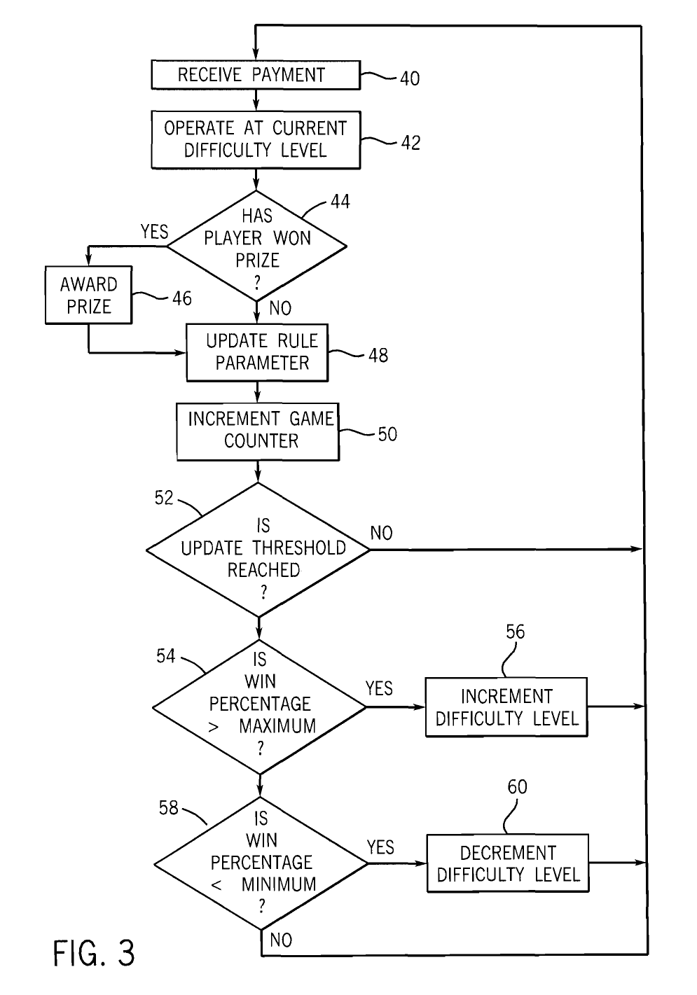

As described previously, it is desirable for the owner/operator to control the number of small prizes and large prizes dispensed by the arcade game to achieve a desired payout percentage for the arcade game. Referring now to FIG. 3, thereshown is a method of operation the arcade game 10 to allow the owner/operator to control the amount of prizes dispensed to help control the profitability of the arcade game 10.

Although not shown in FIG. 1, the arcade game 10 includes a control system that controls the operation of the game field 10, the prize and/or ticket dispensing and all other aspects of the arcade game. In the embodiment shown in FIG. 1, the control system is a microcomputer that controls all aspects of the arcade game operation and is included within the outer cabinet 12.

Referring now to FIG. 3, the method that the control system utilizes to control operation of the arcade game 10 will now be described. Initially, the control system determines if the required amount of payment has been received from the current player in step 40. As described previously, the required amount of payment for each game play can vary depending upon the owner/operator of the game.

Once the payment has been verified, the control system operates the arcade game 10 at the current difficulty level, as indicated in step 42. Initially, the current skill level is the level set by the owner/operator of the game when the game is put into service. Alternatively, the difficulty level can be factory pre-set. However, as will be described in detail below, the current difficulty level of the game may change after a select number of game plays, depending upon various rule parameters and the success level of players at the game.

After the player has completed the game play, the control system determines at step 44 whether the current player has succeeded in winning a prize or tickets from the arcade game. The method illustrated in FIG. 3 will be described assuming that only a single level of prizes are available to the player. As described previously, the arcade game shown in FIG. 1 is capable of dispensing two different levels of prizes to the game player depending upon the results of the game.

Referring back to FIG. 3, if the player has won a prize, the control system dispenses the prize in step 46. After either an unsuccessful game or after the prize has been awarded, the control system updates a rule parameter in step 48. In accordance with the present invention, the rule parameter updated by the control system in step 48 can be various different parameters important to the owner/operator of the game to maintain the profitability of the arcade game. In one example, the rule parameter could be a winning percentage of the game that is based upon the number of games won per the number of games played. The winning percentage can be calculated over various different game play intervals. For example, the winning percentage could be calculated over the past 100 games, over the active life of the game, or over any other interval deemed relevant by the owner/operator. In accordance with the present disclosure, the winning percentage is calculated for the number of game plays that have occurred since the last update to the difficulty level of the game. Additionally, the winning percentage is also determined over the life of the game.

Alternatively, the rule parameter could be a payout percentage for the game, which will depend upon the amount of money received by the machine relative to the value of prizes/tickets dispensed by the arcade game. As an example, an operator may desire to have a payout percentage of 40%-50% of the total money received by the game. In order to calculate a payout percentage, the control system needs to receive input from the owner/operator as to the cost per play as well as the value of the first level prizes and the second level prizes. Based upon this information entered into the control system, the control system can determine the payout percentage for the arcade game over a period of time or number of games. As with the winning percentage, the payout percentage can be calculated per number of games played, over a selected period of time, or any other interval deemed relevant by the owner/operator.

In addition to the winning percentage and payout percentage, it is contemplated that various other parameters could be utilized that would be relevant to the owner/operator of the arcade game while operating within the scope of the present invention. Throughout the remaining portions of the disclosure, the term “rule parameter” will refer to a parameter of interest to the owner/operator of the arcade game and will be utilized to determine the difficulty level of the game as the game is played.

After the rule parameter has been updated in step 48, the control system increments the game counter in step 50. The game counter 50 keeps a running total of the number of game plays that have occurred since the game has been put into play. Additionally, the game counter can also keep a running count of the number of games played since the last update to the difficulty level of the game.

After the game counter has been incremented, the control system determines in step 52 whether an update threshold for the game has been reached. The update threshold can either be factory pre-set or adjusted by the owner/operator of the arcade game. In one embodiment, the update threshold is a number of games played since the last update to the difficulty level. In the embodiment shown in FIG. 3, the update threshold is set at 100, although other thresholds are clearly contemplated as being within the scope of the present invention. If the update threshold is set at 100, the difficulty level of the arcade game will be updated after 100 plays of the arcade game. This value can be reduced well below 100 if the operator wishes to exert greater control on the number of prizes awarded to players.

In addition to updating the difficulty level after a threshold number of games have been played, it is contemplated that the difficulty level of the arcade game could also be updated based upon many other different criteria. As an example, it is contemplated that the difficulty level of the game could be updated immediately upon two large prizes being awarded to players in succession. Additionally, the difficulty level could be modified every time a large prize is awarded or upon a selected number of consecutive awards of the small prize. Most importantly, the difficulty level of the game can be adjusted based upon a selected threshold set by the owner/operator of the arcade game.

If the update threshold has not been reached in step 52, the system returns to step 40 and awaits payment from the next player. This process repeats until the update threshold is reached in step 52. Once the update threshold has been reached, the system determines in step 54 whether the rule parameter, such as the winning percentage calculated in step 48 exceeds a maximum limit. As an example, the arcade game may be factory programmed to set the maximum winning percentage to be 25% for the last 100 game plays. The maximum limit used by the control system in step 54 can be adjusted by the owner/operator depending upon the profitability of the arcade game, the value of prizes being dispensed and the value of each of the prizes being dispensed.

If the system determines in step 54 that the winning percentage exceeds the maximum limit, the system will increment the difficulty level (see FIG. 5) of the game by one level. In the arcade game shown in FIGS. 1 and 2, the difficulty level of both round 1 and round 2 may be increased by one level, as can be understood by the game settings shown in FIG. 5. Although the preferred embodiment contemplates only a single difficulty level increase when the winning percentage exceeds the maximum limit, it is contemplated that the difficulty level could be increased by more than one level and that more than one limit could be set in step 54. As an example, a first level limit could be set at 25%, which would result in an increase of a single difficulty level, while if the winning percentage exceeds 35%, the difficulty level could be increased by two. In either case, it should be understood that when the winning percentage exceeds a maximum limit, the difficulty of one or both levels of a multi-level game can be increased to reduce the likelihood that the next player playing the arcade game will be successful in obtaining a large or small prize. However, it should also be understood that even if the difficulty level is increased to the maximum level, it is still possible for an extremely skilled player to obtain a prize from the arcade game.

If the control system determines in step 54 that the winning percentage is less than the maximum limit, the control system then determines, in step 58, whether the winning percentage is less than a minimum winning percentage. In the embodiment shown in FIG. 3, the minimum limit for the winning percentage can be set at 10%. Thus, if the arcade game is returning prizes in less than 10% of the games played, the control system determines that the difficulty level is too high for the level of players using the arcade game. If the system determines that the winning percentage is below the minimum limit, the control system decreases the difficulty level in step 60. In the embodiment shown, the difficulty level is decreased by a single level if the loss percentage is below the minimum limit. As with the maximum limit described above, the minimum limit can be adjusted by the operator. Further, the decrease in the difficulty level could be either a single level or multiple levels depending upon the actual winning percentage. For example, if the winning percentage is below 5%, the difficulty level could be decreased by two levels rather than the standard single level.

Although the embodiment shown in FIG. 3 describes increasing or decreasing the difficulty level based upon a winning percentage, it should be understood that the winning percentage is only one of several different rule parameters that could be utilized while operating within the scope of the invention. As described previously, payout percentage is also one likely rule parameter that could be utilized while operating within the scope of the present invention. As an example, it is contemplated that if the control system determines that the payout percentage is greater than a maximum limit, such as 50%, the difficulty level of the game would be increased. Likewise, if the payout percentage is less than a minimum limit, such as 20%, the control system determines that the difficulty level is too high for the level of players using the arcade game and decreases the difficulty level.

As can be understood by the two examples set forth above, the control system operates using a rule-based algorithm to determine whether or not the rule parameter exceeds a maximum limit or is below a minimum limit. If the rule parameter falls outside of the rule-based limits, the control system utilizes a rule-based algorithm to either increase the difficulty level or decrease the difficulty level of the arcade game. The use of a rule-based algorithm to compare a rule parameter to a user-selected maximum and minimum limit allows the control system to automatically adjust the difficulty level of the game based upon owner/operator parameters.

After the difficulty level has either been increased in step 56, decreased in step 60 or left the same, the control system returns to step 40 and waits for the next payment from a new player. Once the new payment has been received, the control system will operate the game at the current difficulty level, which may be increased or decreased relative to the original level set by the operator when the arcade game was placed into service.

Although the embodiment shown in FIG. 3 indicates that the arcade game will be operated at the updated difficulty level upon receipt of the next payment, it is contemplated that a delay could be implemented between the updates to the difficulty level in steps 56, 60 and the operation of the arcade game at the updated difficulty level. As an example, it may be desirable to allow a period of time to expire from the update to the difficulty level before the updated difficulty level is implemented for a game player. In some states, regulations require that when a player begins playing a game, the player can expect the difficulty level of the game to remain constant while the player continues to play. In such jurisdictions, a delay would be required before the difficulty level of the game can be implemented. In such an embodiment, the delay may be a period of time from the change to the difficulty level until the implementation of the changed difficulty level, a period of inaction of the arcade game or a selected number of game plays from the update to the difficulty level to the implementation of the newly updated difficulty level.

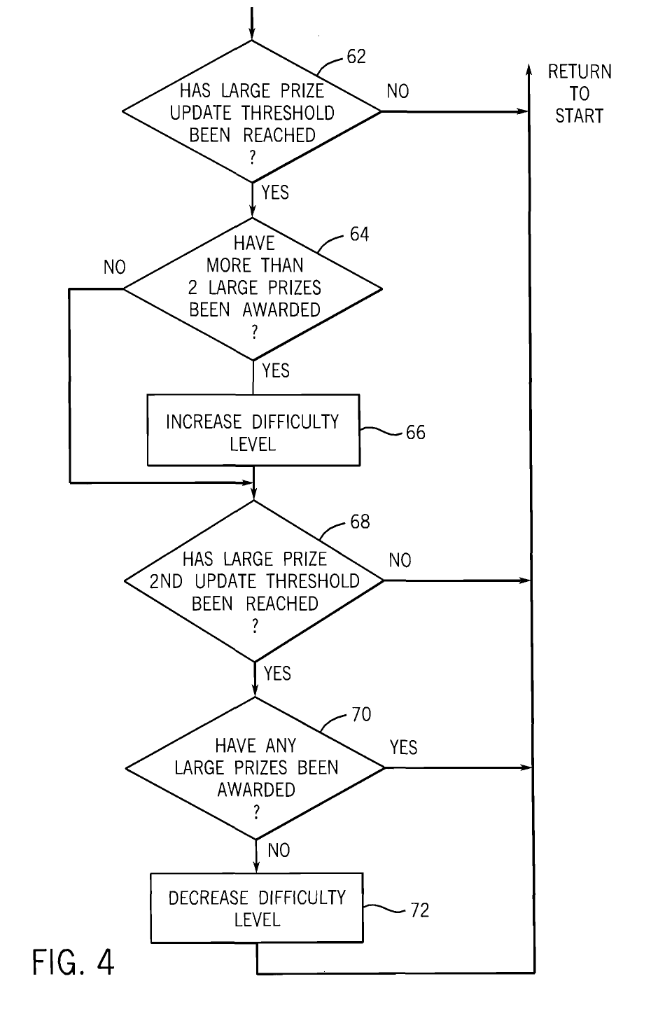

As described above, the method of operation shown in FIG. 3 is particularly useful in an arcade game that returns a single level of prizes each having a relatively consistent value. In the arcade game 10 shown in FIG. 1, the game includes a first level of prizes 16 and a second level of prizes 18 that have vastly different values. The method of FIG. 4 provides for a method of operation that allows the control system to further adjust the difficulty level based upon the number of large level prizes returned by the arcade game. The operational steps shown in FIG. 4 can occur following step 58 shown in FIG. 3.

Referring now to FIG. 4, the control system first determines in step 62 whether the large prize update threshold has been reached. As with the update threshold 52 shown in FIG. 3, the large prize update threshold is the number of games played since the last update to the difficulty level. In the embodiment of the invention described, the large prize update threshold will be 100 plays since the last difficulty level update. If the system determines in step 64 that more than two large prizes have been awarded since the last difficulty level update, the system increases the difficulty level in step 66. Preferably, the difficulty level is increased by at least one level if more than two large prizes have been awarded.

Following the increase in difficulty level of step 66, the control system determines in step 68 whether the system has reached a second large prize update threshold. Preferably, the second update threshold is much greater than the first update threshold of step 62. As an example, the second update threshold may be set at 1,000 plays. The purpose for the second update threshold is to determine whether any large prizes have been dispensed by the unit. As described previously, the arcade game 10 must dispense a certain number of large prizes to keep players interested in playing the game. If the arcade game is perceived as being too difficult, players will avoid the game, which will result in a decrease in revenue.

If the arcade game reaches the second threshold, the system determines in step 70 whether any large prizes have been awarded. If large prizes have been awarded in the past 1,000 plays, the system returns to the start and does not make the game any easier. However, if no large prizes have been awarded, the system decreases the difficulty level in step 72. The decrease in difficulty level will allow a player a better opportunity to obtain a prize by playing the game. After the difficulty level has been decreased in step 72, the system again returns to the start and waits for payment from the next player.

As described previously with reference to FIGS. 3 and 4, the control system of the arcade game continuously monitors the rule parameter, such as the payout percentage or the winning percentage of the game and increases or decreases the difficulty level of the game after a pre-selected number of game plays. Each time the difficulty level is changed, the control system stores the change to the difficulty level as well as the winning or payout percentage of the game when the difficulty level is changed. Thus, over the lifetime of the game, the control system tracks the changes in the difficulty level and the rule parameter that results from such a change. This log of changes kept by the control system of the arcade game can be utilized by the owner/operator, or the game manufacturer, to either adjust the game play or change the value of prizes or the cost of game play to result in the desired revenue stream from the arcade game.

It is contemplated by the inventors that the log of changes could be accessed either at the arcade game or remotely through a wide are network (LAN) connection to the game. It is contemplated that the game could be coupled to the internet and the operating characteristics of the game accessed remotely by an operator. Through the remote access, the operator could adjust the difficulty levels, payout or any other operating parameters of the arcade game.

Although the present embodiment is contemplated as allowing the control system to automatically adjust the difficulty levels of the game as the game play progresses, it is also contemplated that the arcade game could contact the owner/operator to request pre-approval of the difficulty level changes. Such communication could take place through cellular communications, paging networks or an internet communication. Additionally, if communication to the game is established, the game could also communicate to the owner/operator the number of prizes remaining in the game, when the game is empty or any other problem that may occur during game play.

As set forth in the above description, the arcade game and method of operation allows an owner/operator to control the number of prizes dispensed from the arcade game without requiring the owner/operator to continuously monitor the number of prizes distributed. Instead, the control system of the arcade game monitors the number of prizes dispensed over a number of game plays and adjusts the difficulty level of the game accordingly. This process repeats for a series of game plays such that the game continuously modifies the difficulty level based upon the number of prizes dispensed. The arcade game allows the user to set various parameters, such as the minimum and maximum winning percentages as well as the frequency that the difficulty levels are updated. By using the arcade game and method of the present disclosure, an owner/operator is able to control the amount of prizes dispensed without needing to be on-site and vigilant in monitoring the game play.

I claim:

1. A method of operating a game of skill, comprising the steps of:
receiving a payment for the game from a current player;
operating the game at a current difficulty level;
determining the outcome of the completed game;
updating a rule parameter of the game based upon the outcome of the game for the current player;
increasing the difficulty level of the game if the rule parameter is above a maximum limit;
decreasing the difficulty level of the game if the rule parameter is below a minimum limit; and
operating the game at the adjusted difficulty level.

2. The method of claim 1 further comprising the steps of:
incrementing a game count after each play of the game; and
updating the difficulty level of the game only when the game count reaches an update threshold.

3. The method of claim 1 wherein the rule parameter of the game is a winning percentage of the game.

4. The method of claim 3 further comprising the steps of:
awarding a prize to the current player after successful completion of the game; and
updating the winning percentage based upon the award of the prize to the player.

5. The method of claim 4 wherein the game awards a plurality of prizes based upon the success level of the player.

6. The method of claim 5 wherein the winning percentage is based upon the level of prize won by the current player.

7. The method of claim 4 wherein the game awards a plurality of levels of prizes based upon the success level of the current player and the winning percentage is updated for each of the plurality of prize levels.

8. The method of claim 7 wherein at least one of the prize levels is a large prize level, wherein the difficulty level of the game is adjusted based on the number of prizes won from the large prize level.

9. The method of claim 2 wherein the update threshold is user selectable.

10. The method of claim 1 further comprising the step of storing the adjustments to the difficulty level for review by an operator.

11. The method of claim 1 wherein the rule parameter is a payout percentage that is based upon a value of prizes awarded to players versus the total payment received by the game play.

12. The method of claim 1 wherein the game is operated at the adjusted difficulty level following a delay after the adjustment to the difficulty level.

13. The method of claim 12 wherein the delay is a time delay from the difficulty level adjustment.

14. The method of claim 12 wherein the delay is a number of games since the adjustment to the difficulty level.

15. A method of operating a game of skill, comprising the steps of:
operating the game at a current difficulty level;
calculating a winning percentage of the game over a plurality of game plays;
counting the number of game plays since the last update to the difficulty level; and
updating the difficulty level of the game after a predetermined number of game plays since the last update to the difficulty level based upon the winning percentage of the game over the predetermined number of game plays.

16. The method of claim 15 further comprising the steps of:
increasing the difficulty level of the game when the winning percentage is above a maximum limit; and
decreasing the difficulty level of the game if the winning percentage is below a minimum limit.

17. The method of claim 15 wherein the predetermined number of game plays, maximum limit and minimum limit are user selectable.

18. The method of claim 15 further comprising the steps of:
awarding a large prize to a player upon successful completion of the game of skill; and
updating the difficulty level when the number of major prizes awarded exceeds a maximum number.

19. A method of operating a game of skill, comprising the steps of:
operating the game for a current player at a current difficulty level;
determining the outcome of the current completed game;
updating a rule parameter of the game based upon the outcome of the current game for the current player;
modifying the difficulty level of the game based upon the updated rule parameter; and
operating the game at the modified difficulty level after a delay following the current game.

20. The method of claim 19 wherein the delay is based upon a period of time since the modification to the difficulty level.

21. The method of claim 19 wherein the delay is based upon the number of games played since the modification to the difficulty level.

22. The method of claim 19 wherein the rule parameter is a winning percentage of the game based upon the number of games played, wherein the difficulty level of the game is increased if the updated winning percentage is above a maximum limit and the difficulty level of the game is decreased if the winning percentage is below a minimum limit.

23. The method of claim 19 wherein the rule parameter is a payout percentage based upon the monetary value of prizes awarded and the payments received by the game, wherein the difficulty level of the game is increased if the updated payout percentage exceeds a maximum limit and the difficulty level of the game is decreased if the updated payout percentage is below a minimum limit.

24. The method of claim 19 wherein the limit for the rule parameter to adjust the difficulty level of the game is user selectable.
